(19) United States
(12) Patent Application Publication
(10) Pub. No.: US 2006/0078464 A1
(43) Pub. Date: Apr. 13, 2006

(54) Anti tampering arrangement

(76) Inventors: Peter Alleving, Alingsas (SE); Anders Unger, Ravlanda (SE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/247,722

(22) Filed: Oct. 11, 2005

(30) Foreign Application Priority Data
Oct. 11, 2004 (EP) 04024159.8

(51) Int. Cl. G01N 31/00

(52) U.S. Cl. 422/62; 436/55

(57) ABSTRACT

The present invention relates to a system and a method for determining degradation of ozone conversion efficiency of an ozone-converting device in a vehicle. The system includes a heat-exchanging device, such as a radiator, covered with a catalytic coating capable of reducing ozone of the ambient air. The system further includes at least one temperature sensor for measuring the temperature of heat-exchanging device. The temperature is compared to a reference temperature in order to determine degradation in the devices ozone-converting efficiency.

### FIELD OF THE INVENTION

The present invention relates to a device for converting ozone in a vehicle, and more specifically to diagnosing degradation in device performance based on a comparison of its temperature to a reference temperature.

### BACKGROUND AND SUMMARY OF THE INVENTION

It is known that ozone exists next to the surface of the ground up to a height of 1000 meters, which is an air pollution formed by chemical reactions between NOx and NMOG (Non Metan Organic Gases) during the influence of the sun. A high percentage of ozone in the air near the surface of the ground can irritate the mucous membranes and the lungs of human beings and animals and is harmful to vegetation as well.

A type of emission reducing equipment is an ozone reducing coating that may be applied to selected parts of a vehicle, for example the radiator. One example of coating which is used for direct ozone reduction (DOR) is manufactured by the Engelhardt Corporation™ under the name Premair®. This type of coating converts ozone to oxygen. The degree of ozone conversion depends on radiator design, radiator temperature, radiator air flow and the ambient ozone temperature.

A vehicle having a radiator provided with a DOR-coating is marked with an additional emission control label. The label informs a mechanic or a garage that the vehicle is provided with a DOR-radiator, which when removed must be replaced by a new radiator or a replacement DOR-radiator for receiving said emission credits initially. An air certificate issued by California Air Resources Board (CARB) for the vehicle in question requires that a replacement DOR-radiator then is mounted for obtaining the awarded emission credits.

As a result of the exposed position of the radiator it has been found that the catalytic function may degrade due to ageing and contamination without the driver receiving any information thereof.

Different types of systems for determining the ozone conversion of such a catalytic coating or the like are described in the pending European patent applications Nos. 01850085.0 and 0.01850084.3. Amongst others, a “simple” system is described wherein a first temperature sensor is arranged to measure the temperature of the coolant in the radiator, for example at the radiator inlet. Since the catalytic material has to achieve a particular temperature before the ozone conversion can take place, an initial approximation of the degree of conversion of the radiator provided with the catalytic coating can be performed by means of measuring if a so-called “light-off temperature” of the catalytic material has been reached. A DOR-coating will be active at temperatures above approximately 60° C. so that the described temperature at the radiator inlet is a good indicator if, and for long, the ozone conversion process has been active during a cycle or general driving.

However, more complicated systems including so-called ozone sensors also exist see the pending US patent applications 2003/0131650 and 2003/0093990. These types of systems comprise a great number of expensive components, whereby these types of systems in their entireties are very expensive.

Further emission credits can be awarded if the vehicle with the “simple system” described above is provided with some form of on-board diagnostics (OBD) for monitoring the function of the ozone converting member.

In the case of an arrangement comprising a temperature sensor indicating the ozone conversion, the conditions for obtaining further emission credits are that 1) the diagnose system is not removable without it is destroyed, and 2) it should be indicated that the diagnose system is located on a functioning (i.e. ozone converting—if the ignition temperature of the ozone converting member has been reached) DOR radiator of the vehicle. In this context it must be emphasized that all sorts of emission credits are advantageous since the different types of emission credits can be interchangeable with each other by CARB.

A problem with the described type of DOR-radiators is that they are more expensive than a standard replacement radiator. When replacing the DOR-radiator a user may be tempted to buy a standard radiator. In the described type of simpler OBD-systems for DOR applications for giving more emission credits comprising at least one temperature sensor for indicating the ozone conversion, it will be necessary to remove the temperature sensor from the discarded DOR-radiator and then mount it on an approved replacement radiator in an approved way in order to avoid an error message from the OBD-system. For avoiding tampering of such OBD-systems, the temperature sensor can be provided with an irreversible attachment in form of an anti-tampering device which also is described in the pending European Patent application No 04002825.0. The anti-tampering device may comprise a radiator clip which is part of an electrical circuit. If the radiator clip is removed or cut the MIL lamp should be turned on as soon as the electrical circuit is cut. Furthermore, an encrypted message should be sent at least once per driving cycle. The encrypted message is amongst others used to verify that it really is the original sensor mounted on the radiator provided with an approved coating which converts the required ozone. A signal comprising the encryption message may be transmitted through an electrical wire, a CAN bus, by a wireless network or any another suitable means. The encryption message will make it more difficult for a third part manufacturer to make a “fake box” or the like.

Thus, in an attempt to tamper the described OBD system it might be possible to cut out a part of the radiator being provided the described temperature sensor and the anti-tampering device so that they hang freely in the air next to a replacement radiator. Then the sensor is still connected to the ECU (i.e. the electrical circuit is not cut), and the MIL lamp doesn't not indicate this type of tampering if the encryption message is not designed in the right way. In another possible attempt to tamper the described OBD system the sensor could be provided on the outside of the replacement radiator, on a hose of the coolant, or in another location which provides the ignition temperature (above approximately 60° C. as mentioned above) having a capacity to convert the ground level ozone. Obviously, the temperature condition for converting the ground level ozone then is fulfilled but the system does still not authentically indicate that the sensor is provided on a functioning (ozone converting if the ignition temperature of the ozone converting member has been reached) radiator of the vehicle. This emphasizes the importance of an OBD system for indicating authenticity of the stated functionality (stated by the arrangement for converting ozone or by a so-called fake box included therein) of the conversion of ground level ozone including an anti-tampering system comprising an encryption message indicating an authentic functionality of the ozone converting arrangement.

### SUMMARY OF THE INVENTION

This invention is directed to providing a vehicle wherein a driver or maintenance staff can be informed about the authenticity of the stated functionality of an ozone-converting efficiency of a heat-exchanging device covered with an ozone-converting catalytic coating which is provided by monitoring a temperature of the device and comparing it to a reference temperature. The inventive arrangement is a much less expensive arrangement than the existing arrangements, e.g. emission credits relating to tailpipes since the different emission credits are interchangeable with each other.

In accordance with the invention, emission control system for an internal combustion engine, includes: a heat-exchanging device having a coating capable of reducing ozone in ambient air; a thermostat; at least one sensor providing a measurement of a temperature of said heat-exchanging device; and a controller providing an indication of device degradation based on a comparison of said temperature measurement to a predetermined reference temperature.

If degradation is determined, the OBD system of the vehicle indicates that and notifies e.g. the engine control unit (ECU) and the MIL (Malfunction Indication Lamp) lamp. In this way the arrangement indicates and even prevents tampering thereof and indicates if the authenticity of the functionality of the ozone conversion is not correct. Thereby, the vehicle may fulfill certain specified conditions in existing regulations for emissions reducing equipments in vehicles. Thereby, tampering of such a vehicle and arrangement is deterrent.

In an alternative embodiment of the present invention, the heat-exchanging device may be a condenser of a climate-control system, an intercooler of the turbo system or any other component having an operating temperature exceeding 60° C., which component is surrounded of the passing flowing ambient air.

In yet another embodiment of the present invention, the temperature of heat-exchanging device is an engine coolant temperature measured after a conventional engine thermostat in the direction of the coolant flow.

In yet another embodiment of the present invention, a second temperature sensor for measuring the reference temperature which is preferably constituted of the engine coolant temperature measured before the conventional thermostat of the engine coolant of the vehicle in the direction of the coolant flow. Preferably, the second temperature sensor is constituted of the general engine coolant temperature sensor. Alternatively, reference temperature may be estimated based on a mathematical model or formula.

The above advantages and other advantages, and features of the present invention will be readily apparent from the following detailed description of the preferred embodiments when taken in connection with the accompanying drawings, and from the claims.

### BRIEF DESCRIPTION OF THE DRAWINGS

The objects and advantages described herein will be more fully understood by reading an example of an embodiment in which the invention is used to advantage, referred to herein as the Description of Preferred Embodiment, with reference to the drawings, wherein:

FIG. 1 is a schematic sketch of an engine and a cooling circuit including a radiator provided with at least one temperature sensor and an engine control unit according a first embodiment of the invention;

FIG. 2 is a front view of the radiator from FIG. 1;

FIG. 3 is a schematic sketch of the connection between the heat-exchanging device, the Engine Control Module and the MIL lamp;

FIG. 4 is a graph showing the engine coolant temperature and the temperature at the radiator inlet before and after a thermostat opening;

FIG. 5 is a raph according to FIG. 4 wherein a first condition relating to the relationship between the engine coolant and the device temperature is shown;

FIG. 6 is a graph according to FIG. 5 wherein a second condition is shown;

FIG. 7 is a graph according to FIG. 5 wherein a third condition is shown;

FIG. 8 is a graph according to FIG. 5 wherein a fourth condition is shown;

FIG. 9 is a graph according to FIG. 5 wherein a fifth condition is shown; and

FIG. 10 is a graph showing the output of the inventive arrangement and method.

### DETAILED DESCRIPTION OF PREFERRED EMBODIMENTS

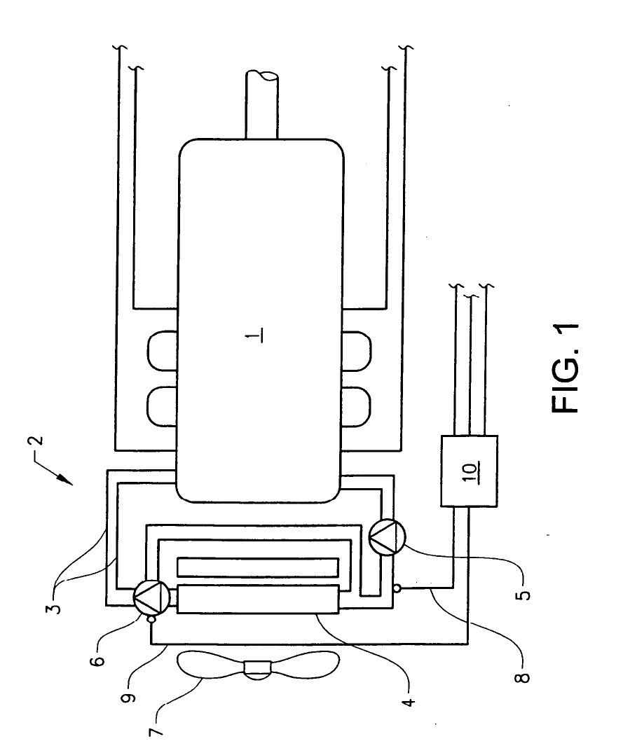

In FIG. 1 an engine 1 for a motor vehicle is shown. The engine 1 is preferably constituted by an internal combustion engine (ICE). A cooling circuit 2 is coupled to the engine 1. The cooling circuit 2 is of a conventional type and normally comprises cooling channels 3 (not shown in greater detail) included in the engine 1 and cooling channels 3 outside the engine 1, at least one heat exchanging member or a heat-exchanging device 4 which is arranged for heat emission to the environment, a coolant pump 5 which is arranged to drive the engine coolant around inside the coolant circuit 2, and a thermostat valve 6 which is arranged to open and shut the flow of the engine coolant through the heat-exchanging device 4 and instead allow the engine coolant to by pass the heat-exchanging device 4 in a parallel channel.

A fan 7 is arranged in connection with the heat-exchanging device 4 in order to ensure that the air flow through the heat-exchanging device 4 is sufficient also when the vehicle drives slowly or stands still, e.g. during idling. The fan 7 can be driven in any well-known way to a person skilled in the art, i.e. by means of belt driving or chain driving from a power outlet coupled to the fan 7.

In a preferred embodiment of the invention, the heat-exchanging device 4 is preferably a radiator, but may also be a condenser of the climate system, an intercooler of the turbo-system or any component having an operating temperature which exceeds 60° C. and is surrounded by the passing, flowing ambient air during operation of the vehicle.

The radiator 4 is at least partially coated with a catalytic material such as an ozone reducing (alt. converting) coating, for example a DOR coating. In this context ozone conversion or ozone reduction relates to the conversion of ozone (O₃) to oxygen molecules (O₂) and oxygen atoms (O). The chemical process is not described any more hereinafter but the degree of ozone is thus reduced in the described ozone conversion process.

In order to detect the authenticity of the functionality of the stated ozone conversion of the radiator 4, a first 8 and a second 9 sensors are connected to a control unit 10. The sensors 8, 9 are preferably a first 8 and a second 9 temperature sensor. The first temperature sensor 8 is preferably located at the inlet of the radiator 4 or adjacent thereto. This first temperature sensor 8 is described in even greater detail below. The second temperature sensor 9 is preferably a general coolant temperature sensor of the vehicle measured upstream the thermostat 6, which sensor 9 is also positioned adjacent the thermostat 6.

The control unit 10 is preferably an engine control unit e.g. a so-called ECU, ECM, CPU or the like. The temperature sensors 8 and 9 are connected to the ECU 10 via an electrical circuit 30, for example an electrical wire or a CAN bus, by a wireless network or any another suitable means.

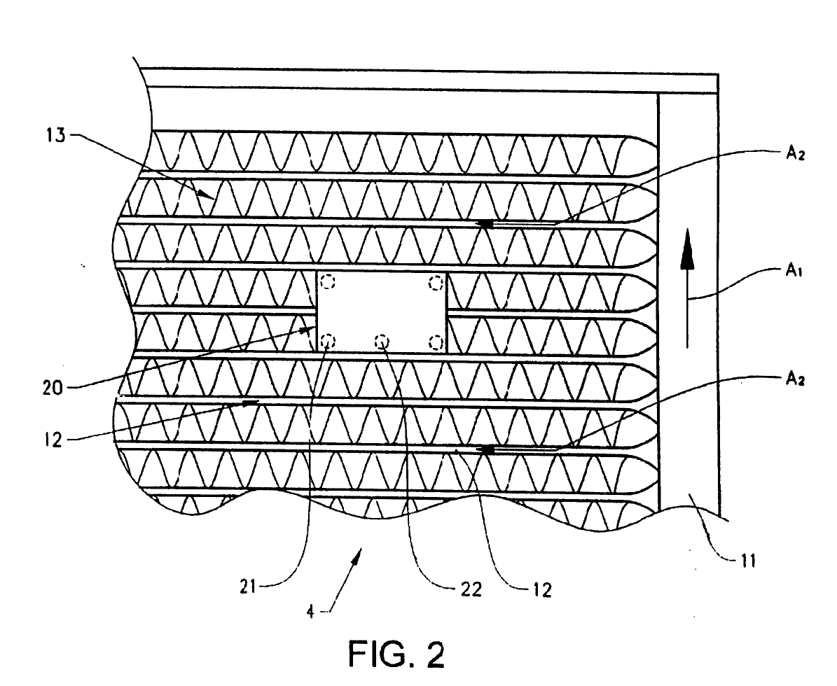

The radiator 4 is shown in a front view in FIG. 2. A partial section of the radiator 4 is provided with an inlet tank 11 into which the engine coolant from the engine 1 enters as shown by the arrow A1. The engine coolant flows from the inlet tank 11 to an outlet tank (not shown in the figures) through a number of cooling channels 12. The flow direction through the cooling channels 12 is indicated by the arrows A2. A section of corrugated sheet metal fins 13 is arranged between each cooling channel 12. When the vehicle is moving, or when the fan 7 is actuated, the ambient air flows through the corrugated fins 13 and cools the engine coolant flowing through the cooling channels 12.

In the preferred embodiment of the invention, an anti-tampering device (ATD device) 20 is attached to the radiator 4 for prevent tampering of the inventive arrangement. The ATD device 20 is attached at the inlet 11 of the radiator 4 or adjacent thereto by at least one attachment pin 21, e.g. in each corner of the ATD device 20, see FIG. 2.

The ATD device 20 has the ability to measure the temperature of the engine coolant passing its position, i.e. the temperature of the engine coolant at the inlet 6 of the radiator 4. As already mentioned above the temperature of the engine coolant is measured by the first temperature sensor 8 in FIG. 1, which in the preferred embodiment is constituted of at least one thermo sensing pin 22. The thermo sensing pin 22 is preferably provided adjacent said attachment pins 21 on the ATD device 20, see FIG. 2.

The attachment pin(s) 21, and/or thermo sensing pin 22, is/are coupled to an electrical circuit, which in turn is connected to the electrical wire, the CAN bus, by a wireless network or any another suitable means for sending a signal to the engine control unit 10. Preferably, the electrical circuit of the ATD device 20 is connected to the engine control module (ECU) 10 via a CAN bus and thereafter to the MIL lamp as well.

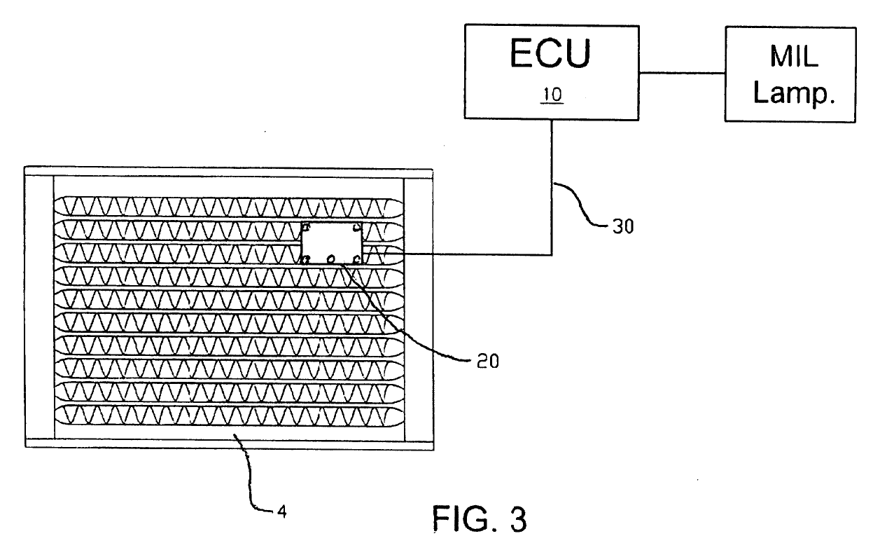

In operation the anti tampering device 20 may send a signal comprising both temperature information and at least one condition relating to the functionality of the ozone conversion via the CAN bus 30 to the ECU 10. In greater detail, the signal may preferably be sent at least once per driving cycle, see FIG. 3. The prerequisites for sending a such signal to the ECU during a driving cycle can for instance be that the terms for cold start are fulfilled, that an opening of the thermostat occurs, that the vehicle does not idle, that the load of the engine is sufficient with regard to the speed or inlet air pressure, etc. Preferably, the encrypted message in form of the signal comprising the temperature data and the at least one condition can at least partly be encrypted.

The encrypted message is used to verify that an original ATD device 20 is mounted on an approved original DOR radiator (converting ozone) in an approved way (for obtaining emission credits from CARB) so that the radiator 4 provided with an ozone converting coating converts ozone as specified but also indicates the authentic functionality of the ozone converting radiator 4, which then cannot be tampered.

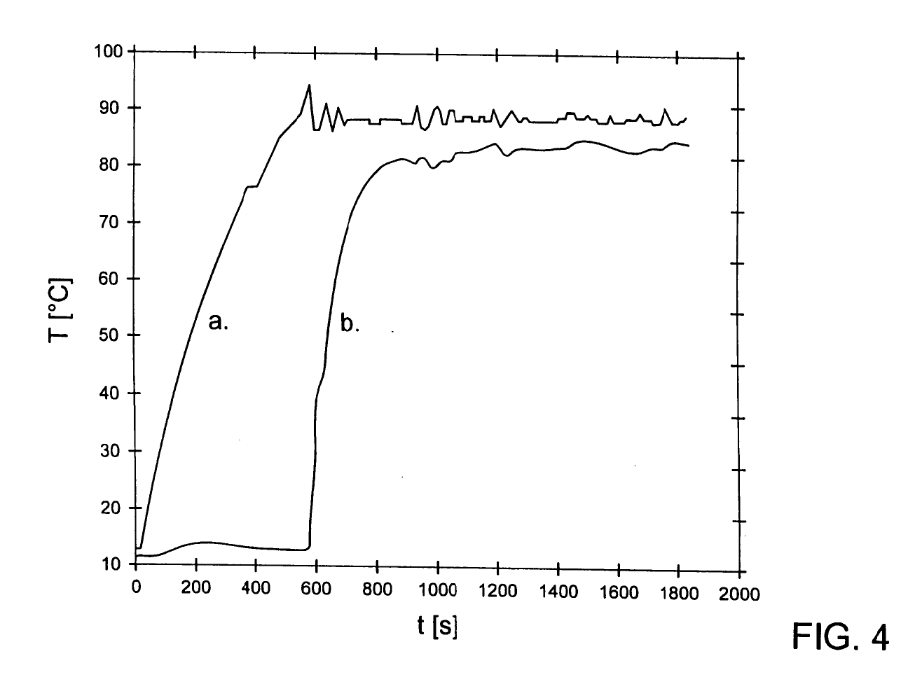

The engine coolant temperature measured before thermostat 6 has a well-known temperature characteristic at cold start which is represented by the curve “a” in FIG. 4.

The engine coolant temperature is thus measured by the temperature sensor 9.

The temperature of the coolant at the inlet 6 of the radiator 4 (at the position of the ATD device 20), which hereinafter is referred to as the ATD temperature, also has a unique characteristic at cold start due to the opening of the thermostat 6, is represented by the curve “b” in FIG. 4. This temperature is thus measured by the thermo-sensing pin 22.

The thermostat 6 opens at coolant temperatures of approximately 85° C. Before that only some leakage of coolant through the thermostat 6 can take place, whereby the ATD temperature is relatively constant, see FIG. 4.

When comparing and analyzing the engine coolant temperature and the ATD temperature represented by “a” and “b” in FIG. 4, conditions for checking the authenticity of the functionality of the inventive arrangement and method can be concluded. The conditions thus refer to data of the relationship between the engine coolant temperature and the ATD temperature. The conditions will be described by way of example only and with reference to the embodiments illustrated in the drawings 5 to 9. In another embodiment of the invention additional conditions may exist.

Thus, the calibration data in the conditions is only exemplifying and could vary.

For example, a first calibration data relates to that the thermostat 6 preferably closes at 80° C. but this temperature value may vary between 70-90° C.

A second calibration data relates to that the thermostat 6 preferably opens at an engine coolant temperature of 85° C. but this temperature value may vary between 80-95° C.

Further calibration data relates to the ambient air temperature for the diagnoses to take place, for example a maximum ambient air temperature value and a minimum ambient air temperature value. The calibration data relating to the maximum air temperature value is preferably 35° C. but may vary between e.g. 20-55° C. The calibration data relating to the minimum air temperature value is preferably 4° C. but may vary between −40 to 20° C.

Still a condition may relate to a cold start at diagnose and thereby the soak time from the shutdown of the vehicle from the previous operation. For example, in a preferred embodiment calibration data of the soak time of 16000 seconds can be used. However, the calibration data could be any value such as one week, or even deleted. Further conditions may be set for the warm-up time and the test time of the vehicle. For instance, that the outside ambient air temperature can be too low for thermostat opening to take place.

Different type of filters may be implemented in automatically engineering systems in regulating or control aspects. There can also exist conditions referring to the regulatory function of the system, the CAN bus, the LIN communication, etc.

Preferably, there exists at least one separate condition for checking the authenticity of the actual ATD device 20. A such condition may relate to the maximum obtained temperature of the actual ATD device 20. This calibration data may be 130° C. but could vary between 100-155° C. A further condition may relate to the minimum temperature of the ATD device 20. This calibration data may be −50° C. but could vary between e.g. +5-(−60)° C.

The described minimum and maximum obtained temperatures of the actual ATD device 20 depends on the engine coolant temperature, the ambient air temperature, the engine bay temperature and the surrounding component temperatures.

Further eventual conditions may relate to a minimum vehicle speed or minimum load, a minimum mass flow of coolant through the thermostat 6 or coolant system, etc. For instance, there may exist a condition which relate to that the diagnose doesn't take place until the vehicle has obtain a sufficient load. The actual condition may relate to e.g. a minimum vehicle speed or minimum load, a minimum mass flow of coolant through the thermostat 6 or coolant system. For example, a condition may relate to that the diagnose doesn't take place until the vehicle has obtained and exceeded a velocity of 30 km/h. However, this condition can differ between 0-50 km/h.

Another separate condition of the ATD device 20 may relate to the functionality such as, an internal flag of the ATD device 20, etcetera.

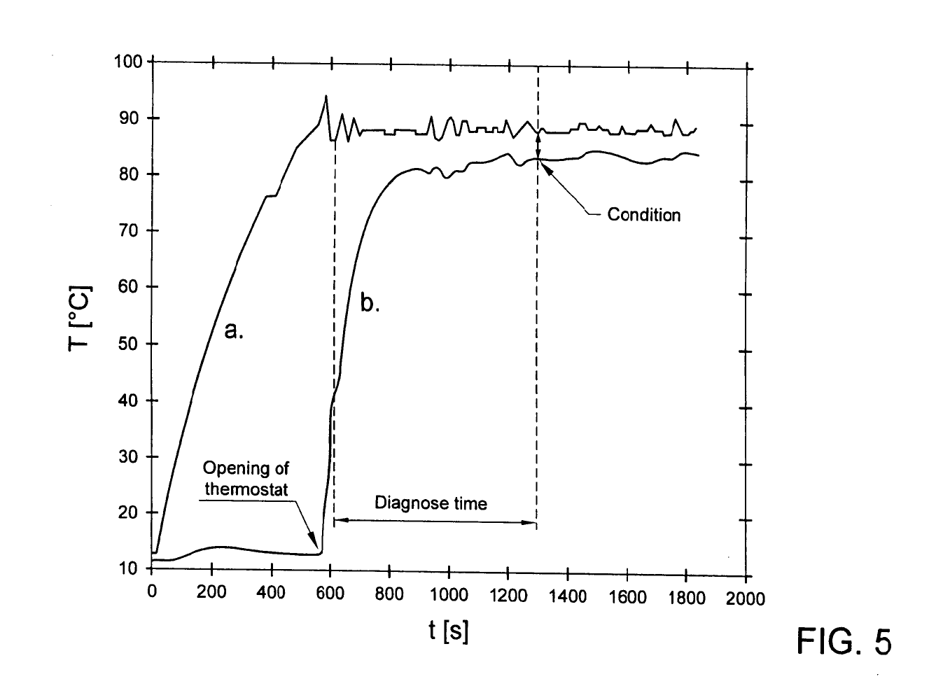

Some basic conditions for the inventive arrangement and method are presented in connection to FIGS. 5-9.

Referring now to FIG. 5, a condition may relate to that the inventive arrangement and method are required to distinguish between the ATD device 20 provided at an original position (e.g., with reference to the manufacturing of the vehicle) and the ATD device 20 removed from the original position and remounted somewhere else. For example, if tampered the ATD device 20 can be remounted onto the coolant hose or onto a similar position. Then it is likely that it is less thermal contact between the ATD device 20 and its new location.

As can be seen in FIG. 5 due to the thermal contact the ATD temperature “b” remains close to the engine coolant temperature “a” when the temperatures are compared after the opening of the thermostat 6. The time before the thermostat opening the engine coolant temperature rises in a traditional way due to the combustion of the engine. The ATD temperature “b” rises rapidly toward the temperature of the engine coolant close within a couple of minutes in time after the opening of the thermostat 6.

The calibration data of the stated condition relating to, e.g., a temperature difference between “a” and “b” after opening of the thermostat 6 may not differ more than preferably 20-5° C. after a cold start of the engine when the temperatures are approximately constant after the heating-up process 1. More preferably, the temperature difference between “a” and “b” may not differ more than preferably 10-15° C., and most preferably, the difference between “a” and “b” may not differ more than approximately 12° C.

If the ATD device 20 would be remounted the ATD temperature would have another temperature characteristic due to another thermal heat transfer between the ATD device 20 and a coolant hose of a rubber or polymeric material than the heat transfer between the ATD device and the radiator 4. Furthermore, if the ATD device 20 is displaced to another position the thermal contact is probably impaired at the new location.

Thus, the inventive arrangement and method can distinguish between an ATD device 20 arranged at the original position and an ATD arrangement 20 remounted onto the coolant hose or a similar position with less thermal contact such as near to a surface.

In this way the characteristic of the ATD temperature is unique. A carefully demounted and removed ATD device 20, which is reinstalled very close to the surface of the inlet 6 of the radiator 4 will most likely not fulfill this stated condition due to lack of thermal contact between the ATD device 20 and the basis.

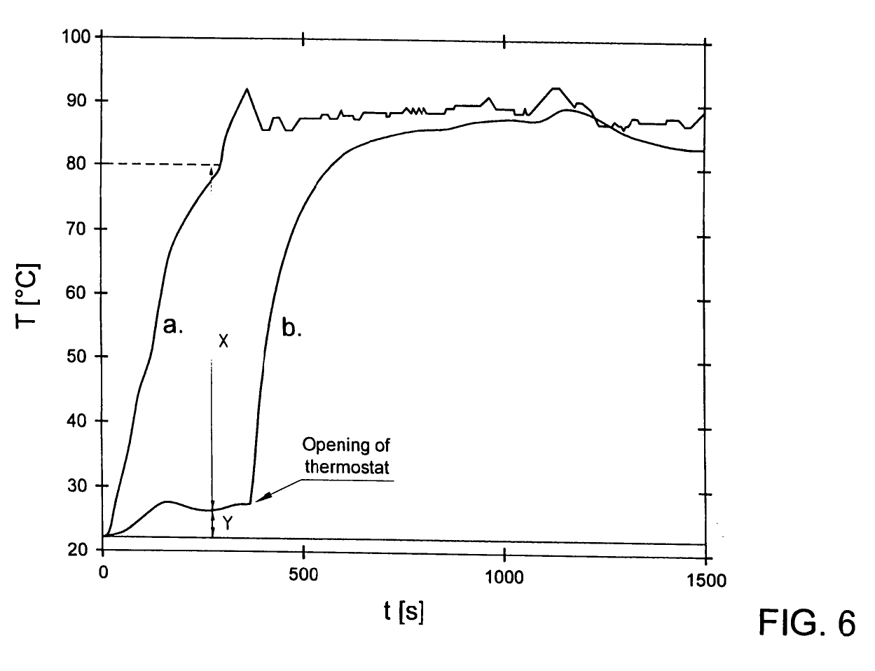

Referring now to FIG. 6, an additional condition which relates to that the inventive arrangement and method are required to distinguish between the ATD device 20 provided at the original position and the ATD device 20 removed and then remounted onto the coolant hose or onto a similar position but also signals of a “fake box” which do not follow the temperature profile of the original ATD device 20, described with reference to FIG. 5.

The ATD temperature “b” of the ATD device 20 which is mounted at its origin position should remain relatively low before the opening of the thermostat 6, see FIG. 6. In a preferred embodiment of the invention, this could be approximated with the gradient or the derivative of the ATD temperature b.

Thus, the ATD temperature “b” should remain low until the thermostat 6 has opened. A carefully removed ATD device 20 which is reinstalled close to the engine 1 will significantly rise in temperature before the opening of the thermostat 6. The difference between the ATD temperature “b” and the engine coolant temperature “a” is calculated just before the engine 1 reaches thermostat opening temperature, see x and y in FIG. 6.

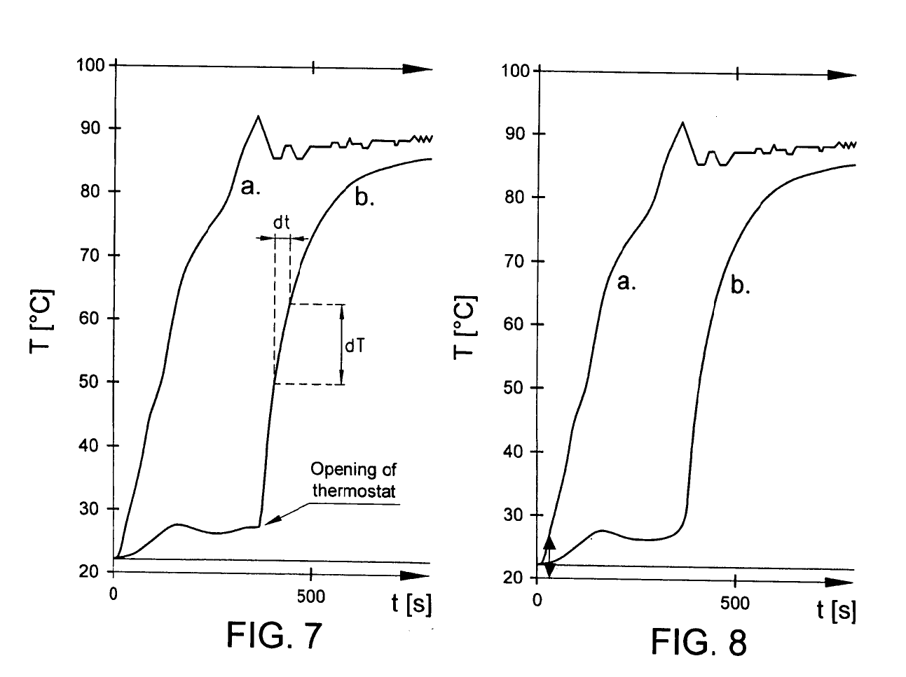

Referring now to FIG. 7, condition relates to that the inventive arrangement and method is mainly required to detect signals of a so-called fake-box representing an ATD device 20.

The ATD temperature “b” of the ATD device 20 arranged at the original position should not rise or change faster than what is physically possible. This condition may detect fake-box signals which behave physically incorrect. The condition is accomplished by estimating the maximum change of the ATD temperature per delta time represented by the maximum or minimum gradient per time unit or maximum derivative.

In a preferred embodiment of the invention, this can be approximated with a first condition relating to the time of the measurement (delta time). Preferably, the calibration data of the time of one measurement is 1-60 seconds, which preferably takes place once per driving cycle. More preferably, the time of the measurement is 10 seconds.

The second condition relates to the temperature increase per delta time, which calibration data preferably is 5° C. per 10 seconds. However, the calibration data could vary between 1 to 25° C. per 10 seconds in another embodiment of the invention.

Referring now to FIG. 8, a condition relates to detection of signals of a so-called fake-box. The ATD temperature should be close to e.g. the engine coolant temperature and the intake air temperature. A fake-box sending out faked start or initial temperatures will at least be detected over time (with help of seasonal changes). The difference between the ATD temperature and the engine coolant temperature and/or the intake air temperature at the start-up of the test cycle can be calculated.

In a preferred embodiment of the invention, this can be approximated with the calibration data that the ATD temperature may not be 20° C. higher than the engine coolant temperature, and that the ATD temperature may not be 20° C. lower than the engine coolant temperature at a cold start. In another embodiment of the invention, other values can be inserted into the variables.

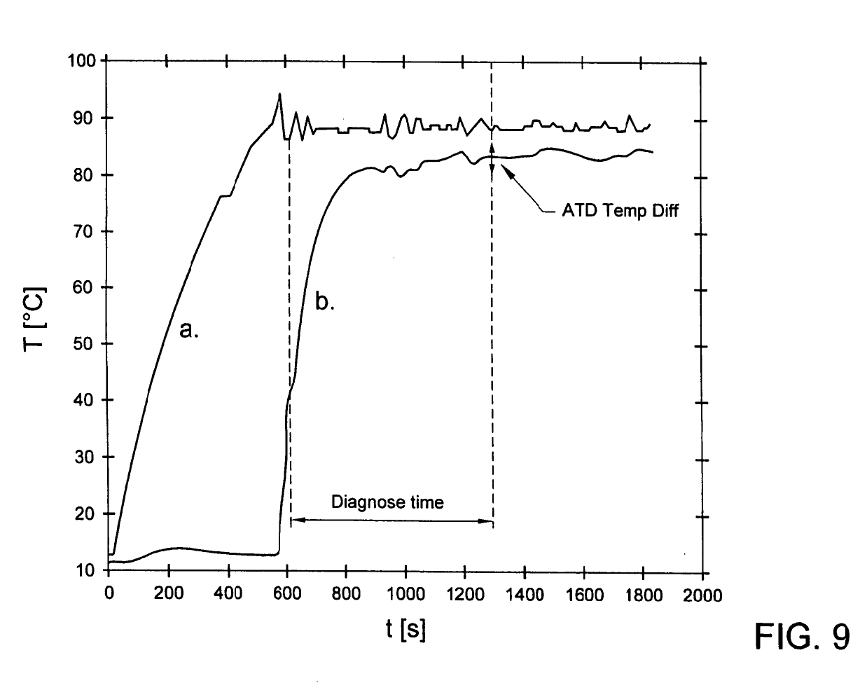

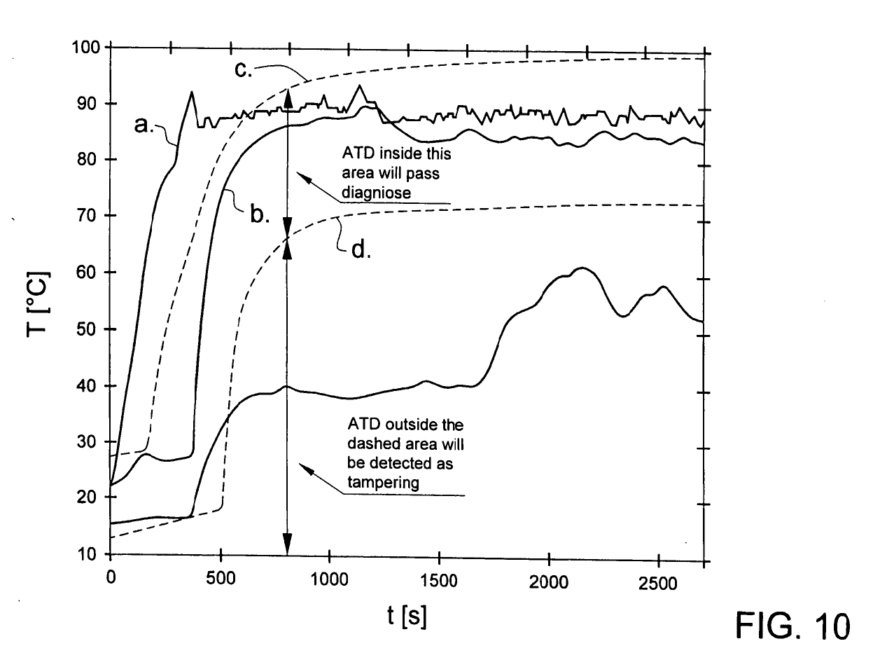

Referring now to FIG. 9, condition relating to the functionality of the ATD device 20 wherein the left and the right thermistor temperature values of the ATD device 20 are compared.

In the original installation of the ATD device 20, the left and the right thermistor temperature values are the same. If one side of a carefully removed ATD device 20 is reinstalled close to the inlet of the radiator 6 with good thermal contact the inventive arrangement may not be able to detect tampering due to the good thermal contact whereas the imbalance in the temperatures between the separate thermistors of the ATD device 20 may be detected.

In a preferred embodiment of the invention, this can be approximated with calibration data that the left and right thermistor values may not differ more than ±5° C. However, in another embodiment of the invention, the left and right thermistor values may not differ more than ±10° C. In another embodiment of the invention, other values can be inserted into the variables.

The preferred embodiment of the inventive arrangement comprises a number of conditions, which mainly relates to the relationship between the engine coolant temperature and the described ATD temperature above. However, for obtain a more refined inventive arrangement a greater number of conditions of the described number of conditions are used in the inventive arrangement. Thus, the different conditions can be combined in any desired way.

As can be seen in FIG. 10 the conditions can be concluded as a first curve “c”, which defines a maximum limit for a possible ATD temperature and a second curve “d” which defines the minimum limit for a possible ATD temperature. If the ATD temperature obtains a greater or a lesser temperature value during the time of the diagnoses, the inventive arrangement and method estimates that the ATD device 20 is tampered.

If the inventive arrangement and method distinguish and detect a tampered ATD device 20 the ECU or MIL lamp can be indicated and turned on in a preferred embodiment of the invention.

The invention has been described above and illustrated in the drawings by way of example only and the skilled person will recognize that various modifications may be made without departing from the scope of the invention as defined by the appended claims.

1. An emission control system for an internal combustion engine, comprising:
a heat-exchanging device having a coating capable of reducing ozone in ambient air;
a thermostat;
at least one sensor providing a measurement of a temperature of said heat-exchanging device; and
a controller providing an indication of device degradation based on a comparison of said temperature measurement to a predetermined reference temperature.

2. The system as set forth in claim 1 further comprising a second sensor providing a signal indicative of an engine coolant temperature measured before said thermostat.

3. The system as set forth in claim 2 wherein said temperature of said device is measured after said thermostat.

4. The system as set forth in claim 1 wherein said heat-exchanging device is a radiator.

5. The system as set forth in claim 1 wherein said heat-exchanging device is a condenser of a vehicle climate control system.

6. The system as set forth in claim 1 wherein said heat-exchanging device is an intercooler of a vehicle turbo system.

7. The system as set forth in claim 1 wherein said heat-exchanging device is a device coupled to an internal combustion engine having an operating temperature of at least 60° C., said device surrounded by flowing ambient air.

8. A method for measuring functionality of an ozone-converting device in a vehicle, comprising:
measuring a temperature of the device;
measuring a reference temperature; and
determining if at least one predetermined condition referring to data of a relationship between said temperature of said and said reference temperature is fulfilled.

9. The method as set forth in claim 8 wherein said reference temperature is measured before an engine thermostat.

10. The method as set forth in claim 9 wherein the ozone-converting device is a heat exchanging device provided with a catalytic coating.

11. The method as set forth in claim 10 wherein the temperature the ozone-converting device is a coolant temperature of said heat exchanging device measured after the engine thermostat.
